(19) United States
(12) Patent Application Publication
(10) Pub. No.: US 2008/0245772 A1
(43) Pub. Date: Oct. 9, 2008

(54) Vacuum Interrupter

(75) Inventors: Nils Anger, Berlin (DE); Roman Renz, Berlin (DE); Ulf Schumann, Berlin (DE); Andreas Stelzer, Berlin (DE)

Correspondence Address: LERNER GREENBERG STEMER LLP, P O BOX 2480, HOLLYWOOD, FL, 33022-2480, US

(73) Assignee: Siemens Aktiengesellschaft, Munich (DE)

(21) Appl. No.: 12/066,557

(22) PCT Filed: Sep. 12, 2005
(86) PCT No.: PCT/DE05/01613

§ 371 Date: Mar. 12, 2008

(51) Int. Cl. H01H 33/66

(52) U.S. Cl. 218/134

(57) ABSTRACT

A vacuum interrupter has a housing, a first contact system, which includes a movable contact piece and a fixed contact piece, and a second contact system, which includes a grounding contact and a grounded mating contact piece. The grounding contact is disposed on a movable contact rod, which is passed out of the housing in a sealing manner, with which vacuum interrupter an interaction of the arc with the grounded mating contact is prevented. The first contact system is held in the interior of the housing using vacuum-tight separating means, which divide the interior of the vacuum interrupter into a first interior having the first contact system and a second interior having the second contact system.

The invention relates to a vacuum interrupter having a housing, a first contact system which comprises a moving contact piece and a fixed contact piece, and a second contact system comprising a grounding contact and a grounded mating contact piece, with the grounding contact being arranged on a moving contact rod which is passed out of the housing through a seal.

A vacuum interrupter such as this is known from DE 100 30 670 C2. The described vacuum interrupter has a first contact system with a fixed contact piece and a moving contact piece which is connected to a current supply bolt as the moving contact rod. The internal area of the housing of the vacuum interrupter is sealed in a vacuum-tight manner from the environment by means of a bellows on the current supply bolt. The first contact system is used for switching and disconnection of an electrical connection. A contact carrier with a moveable contact as a grounding contact on a second contact system is arranged on the moving contact rod, with a stationary contact of the earthing contact being used as a mating contact piece for vacuum interrupter grounding. The mating contact piece is passed to the exterior by means of a thick-walled piece of tubing with a radial connecting flange. In the described vacuum interrupter, the moving contact rod allows three different switch positions:
1. a switch position in which the fixed contact piece is connected to the moving contact piece,
2. an isolating position, in which the fixed contact piece is disconnected from the moving contact piece, with the grounding contact likewise being disconnected from the mating contact piece, and
3. a grounding position, in which the grounding contact is connected to the mating contact piece.

Any arc which is created during the disconnection process is shielded from the mating contact piece, in terms of plasma physics, by a labyrinthine shielding system. Despite this labyrinthine shield, ions from the arc can be attracted by the ground potential on the mating contact piece, leading to the switching capacity of the vacuum interrupter being polarity-dependent.

The object of the present invention is to provide a vacuum interrupter of the type mentioned initially in which the arc is prevented from interacting with the grounded mating contact piece.

According to the invention, this object is achieved in that the first contact system is held in the interior of the housing on vacuum-tight isolating means which subdivide the internal area of the vacuum interrupter into a first internal area with the first contact system and a second internal area with the second contact system.

The vacuum-tight subdivision into two internal areas in which the respective contact systems are arranged advantageously prevents interaction between the ions of the arc during the process of disconnecting the contacts of the first contact system with the grounding contact or the mating contact piece.

In one refinement of the invention, the isolating means comprise an isolating plate, which is held on the housing and has a vacuum-tight bushing. This isolating plate is preferably electrically conductive and offers a simple capability to subdivide the internal area of the housing of the vacuum interrupter into two internal areas which are sealed in a vacuum-tight manner from one another.

In one preferred embodiment, the moving contact rod extends through the isolating plate and is connected in the first internal area to the moving contact piece of the first contact system, and a bellows on the isolating plate forms the vacuum-tight bushing. The bellows advantageously form a vacuum-tight bushing for the moving contact rod, allowing movement of the moving contact rod in order to move the contact pieces, which are arranged on the moving contact rod, between different positions.

In another preferred embodiment, the vacuum-tight bushing is formed by a contact connecting stub, which is incorporated in the isolating plate in a vacuum-tight manner, on the fixed contact piece of the first contact system, and the inner end piece of the moving contact rod forms the moving contact piece of a third contact system whose fixed contact piece is the contact connecting stub. An arrangement such as this offers a further capability to arrange the first and the second contact system in internal areas which are isolated from one another in a vacuum-tight manner, and in which the third contact system has the function of disconnecting the vacuum interrupter.

In one expedient refinement of this embodiment, the moving contact piece of the first contact system is fitted to a further moving contact rod which extends in a vacuum-tight manner into the first internal area. The arrangement of the further moving contact rod advantageously means that the functions of current interruption, switching and disconnection can be carried out independently of one another, thus leading to the design of the vacuum interrupter being more compact since a short distance between the moving and the fixed contact piece is sufficient for current interruption and for quenching the arc while, in contrast, dielectric isolation requires a greater distance between the contact pieces.

In one preferred embodiment, a bellows forms the vacuum-tight bushing for the further moving contact rod. A bellows is an advantageous means for forming a vacuum-tight bushing for the moving contact rod.

In a further refinement of the invention, the fixed contact piece and the moving contact piece are each formed from a copper chromium material. A material such as this advantageously has a high switching capacity with connection resistance at the same time, and results in only minor overvoltages.

In another embodiment, the fixed contact piece and the moving contact piece are each formed from a tungsten carbide silver material with a silver component of between 20 and 50%. A material such as this is likewise suitable for forming the first contact system.

In a further refinement of the invention, the grounding contact and the mating contact piece are each formed from copper. Copper is an electrically highly conductive material and therefore advantageously offers the characteristics for the second contact system as a grounding contact system.

In another refinement, the grounding contact and the mating contact piece are each formed from a copper chromium material. A material such as this has the advantages already described above, and can therefore also be used for the second contact system.

In a further refinement of the invention, the contacts of the third contact system are formed from copper. Copper has the characteristics already described above, and is a suitable material for the third contact system.

In another refinement, contacts of the third contact system are formed from a copper chromium material. A copper chromium material can also advantageously be used for the third contact system.

The invention will be explained in more detail in the following text using the drawing and one exemplary embodiment, with reference to the attached figures, in which:

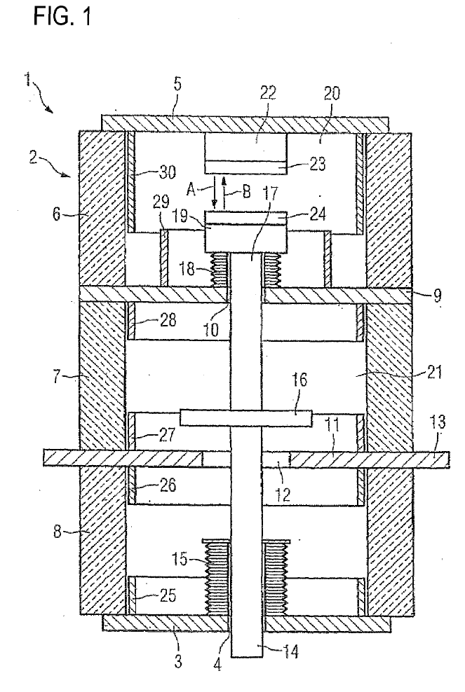

FIG. 1 shows a first exemplary embodiment of a vacuum interrupter according to the invention; and

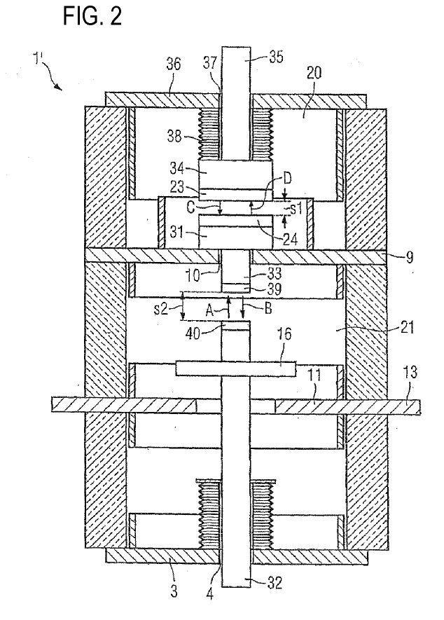

FIG. 2 shows a second exemplary embodiment of a vacuum interrupter according to the invention.

FIG. 1 shows a vacuum interrupter 1 with a housing 2 which comprises a housing plate 3 with a bushing 4, a further housing plate 5 and insulators 6, 7 and 8. An electrically conductive isolating plate 9 is arranged between the insulators 6 and 7 of the housing 2, and has a vacuum-tight bushing 10. A mating contact piece 11 is arranged between the insulators 7 and 8 of the housing 2, is provided with an opening 12 and has a larger external diameter than the insulators 7 and 8, so that a flange-like section 13 on the vacuum interrupter 1 is externally accessible for grounding the mating contact piece 11. A moving contact rod 14 which is conductively connected with an electrical power supply, which is not illustrated, and to an operating device, extends through the bushing 4 of the housing plate 3. A bellows 15 is arranged on the housing plate 3 and on the moving contact rod 14 such that the moving contact rod 14 is passed out of an internal area of the vacuum interrupter in a vacuum-tight manner. The moving contact rod 14 extends through the opening 12 in the mating contact piece 11, with the opening 12 having a considerably larger diameter than the external diameter of the moving contact rod 14. A grounding contact 16 in the form of a contact disk 16 is arranged on a side opposite the bellows 15 with respect to the mating contact piece 11, and its external diameter is larger than the internal diameter of the opening 12. The moving contact rod 14 furthermore extends through the vacuum-tight bushing 10 of the isolating plate 9 and is connected at one end 17 to a moving contact piece 19, with a bellows 18 on the isolating plate 9 and the moving contact piece 19 being used as a vacuum-tight bushing, thus resulting in the internal area of the vacuum interrupter being subdivided in a vacuum-tight manner into a first internal area 20 and a second internal area 21. A fixed contact piece 22 is arranged opposite the moving contact piece 19 in the second internal area, and is firmly connected to the further housing plate 5. The contact pieces 19 and 22 may be either radial magnetic field contact pieces or axial magnetic field contact pieces, which are provided with contact disks 23 and 24, respectively, in order to improve the contact and quenching characteristics of the first contact system. The arrows A and B show the movement direction of the moving contact rod 14. Shields 25, 26, 27, 28, 29, 30 on the housing plate 3, on opposite sides of the mating contact 11, 28 and 29, on opposite sides of the isolating plate 9 on the further housing plate 5 are intended to shield the insulators 6, 7 and 8 against sputtering, and for potential control.

The vacuum interrupter 1 has three different possible positions, which can be assumed by moving the moving contact rod 14 along the movement direction indicated by the arrows A and B. The position shown in the FIG. 1 corresponds to an isolating position of the vacuum interrupter 1. The moving contact piece 19 and the fixed contact piece 22 are physically isolated from one another and are not conductively connected. In this position, there is likewise no conductive connection between the ground contact 16 and the mating contact 11. If the moving contact rod 14 is moved in the direction of the arrow B by means of a drive mechanism that is not illustrated, then the vacuum interrupter 1 assumes the switch position in which the moving contact piece 19 and the fixed contact piece 22 are conductively connected. The vacuum interrupter 1 is in its switched position. If the moving contact rod 14 is moved away from the fixed contact piece 22 in the direction of the arrow A by means of the drive mechanism, then the position shown in FIG. 1 is first of all reached again, corresponding to the isolating position, and when it is moved further in this direction, the vacuum interrupter 1 finally assumes the grounding position, in which the grounding contact 16 forms a conductive connection to the mating contact 11. The movement between the individual positions of the vacuum interrupter 1 is made possible by the flexibility of the bellows 15 and 18, which ensure that the first internal area 20 and the second internal area 21 remain vacuum-tight during the movement of the moving contact rod 14.

FIG. 2 shows a further exemplary embodiment of a vacuum interrupter 1′ according to the invention. In this exemplary embodiment, a fixed contact piece 31 is arranged in the electrically conductive isolating plate 9 such that a contact connecting stub 33 on the fixed contact piece 31 is incorporated in the isolating plate 9, forming the vacuum-tight bushing 10 and extending into the second internal area 21. The first internal area 20 and the second internal area 21 are isolated from one another in a vacuum-tight manner by the isolating plate 9 and the contact connecting stub 33. A moving contact rod 32 extends through the bushing 4 of the housing plate 3 into the second internal area 21, and is sealed in a vacuum-tight manner on the outside by means of the bellows 15. The moving contact rod 32 extends through the opening 12 in the mating contact piece 11 and has a grounding contact 16 on the side of the mating contact piece 11 opposite the bellows. A moving contact piece 34 is arranged fixed on a further moving contact rod 35, which extends through a bushing 37 in the housing plate 36 from the first internal area 20 to the outside. The contact rod 35 is connected to an electrical power supply, which is not illustrated in the figures. A bellows 38 is arranged on the housing plate 36 and the moving contact rod 35 in order to isolate the first internal area 20 from the surrounding area in a vacuum-tight manner. The moving contact piece 34 and the fixed contact piece 31 form the first contact system and are provided with contact disks 23, 24. Shields 25 to 30 are arranged on the respective housing plates, the isolating plate and the mating contact.

In the arrangement shown in FIG. 2, the contact connecting stub 33 of the fixed contact piece 31 and the end of the moving contact rod 32 form a third contact system with contact surfaces 39, 40, with the contact surfaces 39 and 40 being formed by contact disks 39 and 40 on the contact connecting stub 33 and on the end of the moving contact rod, in order to improve the contact characteristics of the third contact system. In this arrangement, a switch position of the vacuum interrupter 1′ is reached on the one hand by the moving contact rod 35 being moved by a drive, which is not illustrated, with the moving contact piece 34 in the direction of the movement arrow C, so that the moving contact piece 34 and the fixed contact piece 31 form a conductive connection, and the moving contact rod 32 is moved upwards in the direction of the moving part A, so that the contact connecting stub 33 of the fixed contact piece 31 and the end of the moving contact rod 32 likewise form a conductive connection. If the moving contact rod 35 is moved in the direction of the movement arrow D, thus disconnecting the contact pieces 31 and 34 from one another, then the conductive connection is broken, with the arc being struck between the fixed contact piece 31 and the moving contact piece 34, and being quenched in the vacuum. A disconnection process in this arrangement takes place by the moving contact rod 32 being moved away from the contact connecting stub 33 of the fixed contact piece 31 in the direction of movement arrow B until a distance which is adequate for dielectric isolation is reached. If the moving contact rod 32 is moved further from the contact connecting stub 33 of the fixed contact piece 31, the vacuum interrupter 1′ is grounded, in which process the grounding contact 16 forms a conductive connection to the mating contact piece 11. The distance s1 between the fixed contact piece 31 and the moving contact piece 34 for current interruption and for quenching of the arc when this arrangement is in the disconnected position is in this case considerably less than the distance s2 required for dielectric isolation between the end of the moving contact rod 32 and the contact connecting stub 33 of the fixed contact piece 31 in the isolating position and is a maximum of s₁=(0.35 mm/kV×rated voltage of the vacuum interrupter [kV]).

### LIST OF REFERENCE SYMBOLS

1,1′ Vacuum interrupter
2 Housing
3 Housing plate
4 Bushing
5 Further housing plate
6, 7, 8 Insulators
9 Isolating plate
10 Bushing
11 Mating contact
12 Opening
13 Flange-like section
14 Moving contact rod
15 Bellows
16 Grounding contact
17 End
18 Bellows
19 Moving contact piece
20 First internal area
21 Second internal area
22 Fixed contact piece
23, 24 Contact disks
25, 26, 27, 28, 29, 30 Shields
31 Fixed contact piece
32 Moving contact rod
33 Contact connecting stub
34 Moving contact piece
35 Moving contact rod
36 Cover plate
37 Bushing
38 Bellows
39, 40 Contact disks
A, B, C, D Movement direction arrows

1-13. (canceled)

14. A vacuum interrupter, comprising:
a housing defining an interior;
a first contact system including a moving contact piece and a fixed contact piece;
a second contact system including a grounding contact and a grounded mating contact piece;
vacuum-tight isolating means in said interior of said housing and dividing said interior into a first internal area with said first contact system and a second internal area with said second contact system; and
a moving contact rod carrying said grounding contact and projecting out of said housing through a seal.

15. The vacuum interrupter according to claim 14, wherein said isolating means comprise an isolating plate held on said housing and having a vacuum-tight bushing.

16. The vacuum interrupter according to claim 15, wherein said moving contact rod extends through said isolating plate and is connected in said first internal area to said moving contact piece of said first contact system, and said vacuum-tight bushing is formed with a bellows on said isolating plate.

17. The vacuum interrupter according to claim 15, wherein said vacuum-tight bushing is formed by a contact connecting stub incorporated in said isolating plate in a vacuum-tight manner, on said fixed contact piece of said first contact system, and an inner end piece of said moving contact rod forms a moving contact piece of a third contact system having a fixed contact piece forming said contact connecting stub.

18. The vacuum interrupter according to claim 17, wherein a first spacing distance between said fixed contact piece and said moving contact piece of said first contact system, in a disconnected position, is less than a second spacing distance between said inner end piece of said moving contact rod and said contact connecting stub of said third contact system in an isolating position, and wherein said first spacing distance corresponds at most to a product of 0.35 mm/kV and a rated voltage of the vacuum interrupter.

19. The vacuum interrupter according to claim 17, wherein said moving contact piece of said first contact system is fitted to a further moving contact rod extending in a vacuum-tight manner into said first internal area.

20. The vacuum interrupter according to claim 19, which comprises a bellows disposed to form a vacuum-tight bushing for said further moving contact rod.

21. The vacuum interrupter according to claim 14, wherein said fixed contact piece and said moving contact piece are each formed of a copper chromium material.

22. The vacuum interrupter according to claim 14, wherein said fixed contact piece and said moving contact piece are each formed of a tungsten carbide silver material with a silver component of between 20 and 50%.

23. The vacuum interrupter according to claim 14, wherein the grounding contact and the mating contact piece are each formed from copper.

24. The vacuum interrupter according to claim 14, wherein said grounding contact and said mating contact piece are each formed of a copper chromium material.

25. The vacuum interrupter according to claim 17, wherein said third contact system has contact surfaces formed of copper.

26. The vacuum interrupter according to claim 17, wherein said third contact system has contact surfaces formed of a copper chromium material.
